(19) United States
(12) Patent Application Publication
(10) Pub. No.: US 2002/0069114 A1
(43) Pub. Date: Jun. 6, 2002

(54) Method and system for placing a purchase order over a communications network

(76) Inventors: Phillip Carl Charette, Farnham (GB); Stephen Robert Woods, Fleet (GB)

Correspondence Address: FINNEGAN, HENDERSON, FARABOW, GARRETT &, DUNNER LLP, 1300 I STREET, NW, WASHINGTON, DC, 20005, US

(21) Appl. No.: 09/726,483

(22) Filed: Dec. 1, 2000

(51) Int. Cl. G06F 17/60

(52) U.S. Cl. 705/26

(57) ABSTRACT

A method and system for placing a purchase order with a product trader for a product over a communication network comprises accessing an information site on a shopping server using a shopping client and downloading program code for executing a shopping cart to the shopping client from the shopping server. The programme code when executed on the shopping client generates a purchase order interface for the user enabling a user to input product selection data and payment data. Order data is generated using the received selection data and payment data and at least the payment data is encrypted. The order data is then transmitted from the shopping client over the communications network to a location for reception by the product trader.

The present invention generally relates to a method and system for placing a purchase order with a product trader for a product over a communications network. With the advent of the World Wide Web, the application of it to commerce has developed rapidly to such an extent that it is now widely used for e-commerce. In prior art e-commerce systems a server is configured to store a website which can facilitate e-commerce transactions. The website is designed to provide product information in the form of web pages. To enable products to be purchased, it has now become common for the web server to host a “shopping cart”. A shopping cart is a facility whereby a user can select products to be purchased and place them into the “shopping cart”. At the end, when the customer has chosen all the required products, payment data which has credit card information can be entered. This is usually performed by accessing a secure server to ensure a secure communication channel between the shopper's computer and the server to ensure confidentiality of the sensitive payment information, In order to provide the electronic shopping cart, the necessary functionality can only be provided by suitable programme code implemented at the server e.g., Java script, Perl, CGI scripts, or active server pages. This requires the server to provide the necessary support for the implementation of the code. Also, because the server receives the payment information in order to process the transaction, the payment information is vulnerable to unauthorised access.

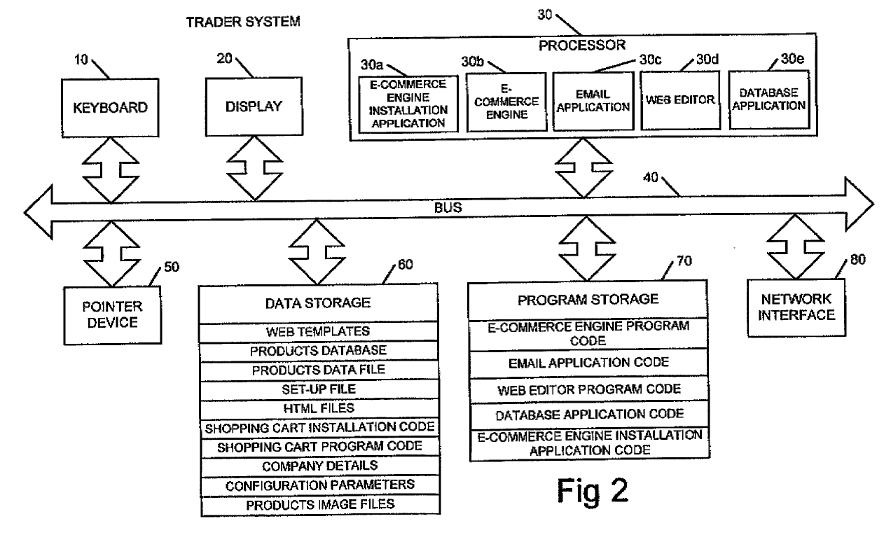

U.S. Pat. No. 5,960,411 discloses a prior art system for placing a purchase order over a telecommunications network. The advance disclosed in this patent is the reduction of the operations required by a purchaser. As can be seen in FIG. 2 of the patent. The arrangement still requires a shopping cart at the server.

It is an object of the present invention to provide a system for enabling a purchase order to be placed over a communications network using a server which has a reduced functionality compared to the prior art.

In accordance with a first aspect the present invention provides a method and system for placing a purchase order with a product trader for a product over a communications network. An information site on a shopping server is accessed by a shopping client. Programme code for executing a shopping cart is downloaded from the shopping server to the shopping client. The programme code is executed at the shopping client to generate a purchase order interface for a user to enable the user to input product selection data and payment data. The input product selection data and payment data is used to generate to order data. At least the payment data of the order data is encrypted and the order data is transmitted from the shopping client over the communications network to a location for reception by the product trader.

Thus in accordance with this aspect of the present invention, when a user of the shopping client wishes to first place a purchase order for a product with a trader, an executable shopping cart is downloaded to the shopping client. Thus the functionality required of the server is reduced to simply requiring the ability to download code. This is a conventional requirement for servers.

The present invention can be implemented over any communications network. However the present invention is preferably implemented over an Internet Protocol network which supports HTTP (Hypertext Transfer Protocol) for the transfer of web pages (HTML). Such a network can comprise the Internet, a local area network, an Extranet, or an Intranet. Thus the information site accessed by the shopping client comprises the web site of the trader in order to view product data such as product information and product cost. If the customer using the shopping client wishes to place an order to make a purchase, the customer will be required to download the executable shopping cart at least on the first visit to the website.

The present invention encompasses requiring a customer to always download the executable shopping cart before placing an order. However, preferably once the executable shopping cart has been downloaded, a subsequent purchase order can be placed simply be executing the shopping cart on the client machine.

In one embodiment, to enable the product range or offer to be modified, the shopping server also stores product data. The product data is downloaded with the executable shopping cart and is used to provide the purchase order interface for the user. Thus for subsequent purchase orders, when the executable shopping cart is executed, in order to take into account the fact that the product range may have changed, product data can be downloaded from the shopping server if necessary. In order to do this, the executable shopping cart makes a connection to the shopping server. The connection comprises a TCP/IP connection. Where the shopping client includes a modem and uses a dial-up connection to the Internet, the executable shopping cart can make a dial-up connection to the network if one is not already made. This dial-up connection will enable a connection to be made to the shopping server to update the product data, and also once an order is placed, it can be transmitted over the network.

In accordance with one embodiment the transmission of the order data comprises the uploading of the order data to a storage location e.g., a directory on the shopping server. The order data can then be retrieved by the product trader by accessing the shopping server and downloading the order data e.g., by using FTP (File Transfer Protocol).

In a preferred embodiment of the present invention, the order data is transmitted as an e-mail to an e-mail address for the product trader. Thus the e-mail need not be directed to the product server. The e-mail will be handled by the user's ISP (Internet Service Provider) in a conventional manner key routed to the mail server used by the product trader, The product trader can then access their e-mail from their e-mail server.

In addition to downloading the programme code for the executable shopping cart and the product data, farther information which can be downloaded to the shopping client is location information to identify where the order data is to be transmitted to. This can comprise a URL (Uniform Resource Locator) and subdirectory for the shopping server, or an e-mail address. Also, the information downloaded can include a key to be used for the encryption of the order data by the shopping client. This further information is, in one embodiment used during installation of the shopping cart on the client machine to set up the shopping cart.

Thus the information stored at the shopping server comprises programme code for executing the shopping car; product data, and information (e.g., web pages) which can be accessed by the shopping client. Thus the server only acts as an information (web page), data and code source.

In accordance with a second aspects the present invention provides a method and apparatus for configuring the shopping server. Product data is generated which includes product information and cost information. The information to be accessed by the shopping client is also generated, The product data, the generated information, and the programme code for executing the shopping at are uploaded to the shopping server.

Thus in accordance with this aspect of the present invention, a trader is able to configure a shopping server to provide a simple system for placing a purchase order without requiring any specific processing capability from the server. This enables the product trader to use any conventional Internet Service Provider that provides web space on their web server. The product trader need not be concerned with the capability of the server provided by the ISP. The product trader simply uploads the necessary data information and code to the server for download by customers.

In this aspect of the present invention, the product data can either be stored separately to the code or incorporated within the code. It is however preferred to separate the product server from the programme code so that the product trader can update the product data without having to modify the programme code. This also enables the clients to use a standard shopping cart code and only retrieve updated product data from the server each time a purchase order is to be placed. The product data comprises far less code for download than the executable shopping cart code and thus the download time for update is short.

In one embodiment a key for use by the shopping client for the encryption of at least payment data is generated and stored in a hidden form at the shopping server. The generated key is used by the product trader to decrypt order data received from shopping clients.

The programme code stored on the shopping server can, in one embodiment, comprise installation code in conjunction with the executable shopping cart. Installation code may include an installation “wizard” to facilitate the installation of the executable shopping cart on the shopping client.

The present invention can be implemented using suitably programmed general purpose computers. The present invention thus encompasses any such suitably programed apparatus, and computer readable code. The computer readable code can be provided to the general purpose computer on any suitable carrier medium such as storage medium e.g., a floppy disk, CD ROM magnetic tape, or programmable memory device or a signal (e.g., an electrical signal carried over a network such as the Internet).

Embodiments of the present invention will now be described with reference to the accompanying drawings, in which:

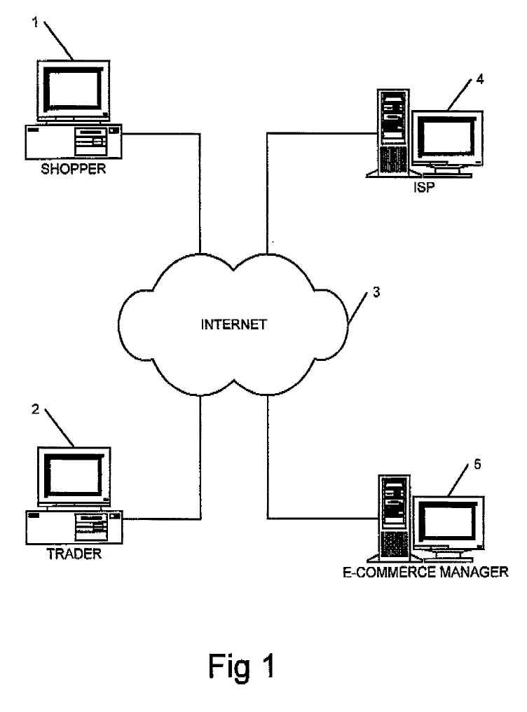

FIG. 1 is a schematic diagram of a system in accordance with an embodiment of the present invention;

FIG. 2 is a schematic diagram of a trader client system in the embodiment;

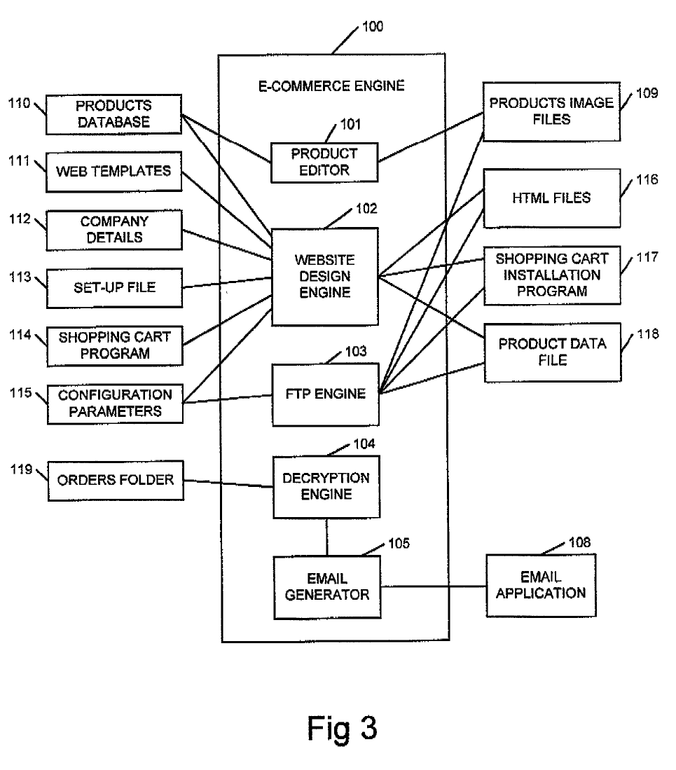

FIG. 3 is a schematic diagram of the functional units in the trader client system in accordance with the embodiment,

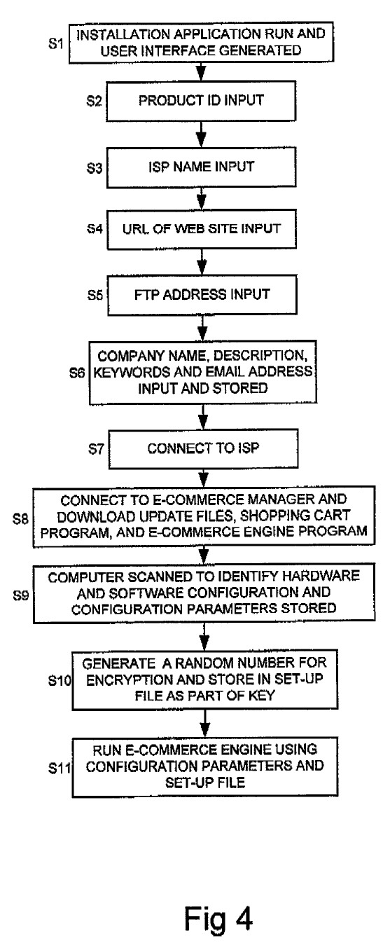

FIG. 4 is a flow diagram illustrating the installation of programme code on the trader client system to provide the capability to configure a shopper server in accordance with the embodiment,

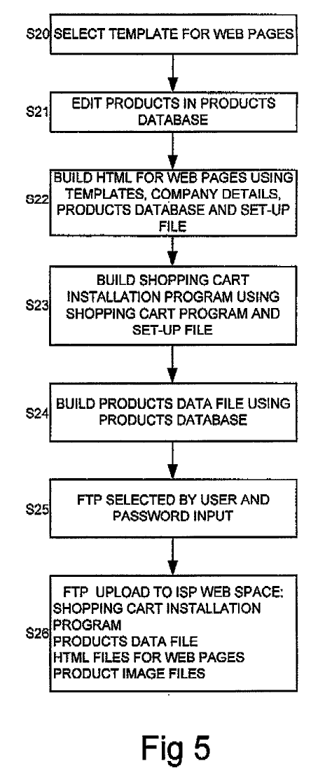

FIG. 5 is a flow diagram illustrating the process of configuring the shopper server system in accordance with the embodiment;

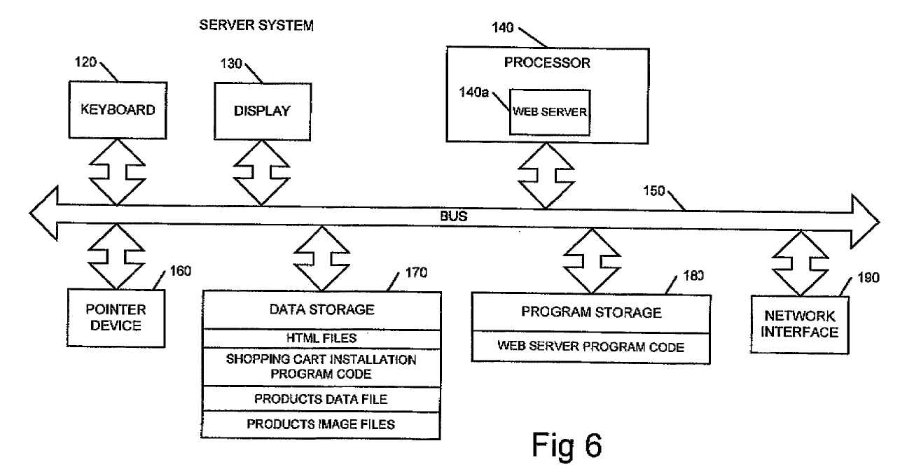

FIG. 6 is a schematic diagram of the shopper server system in accordance with the embodiment,

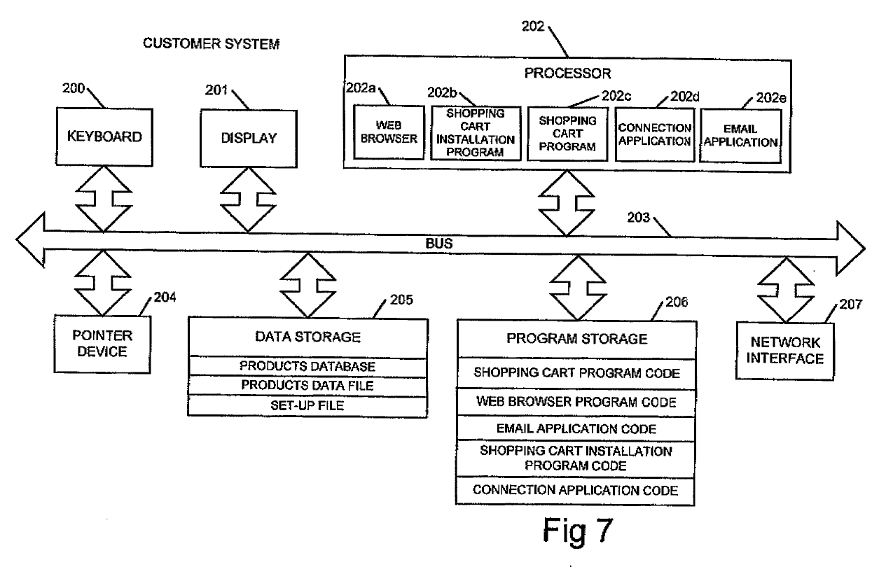

FIG. 7 is a schematic diagram of the shopper client system (customer system) in accordance with the embodiment,

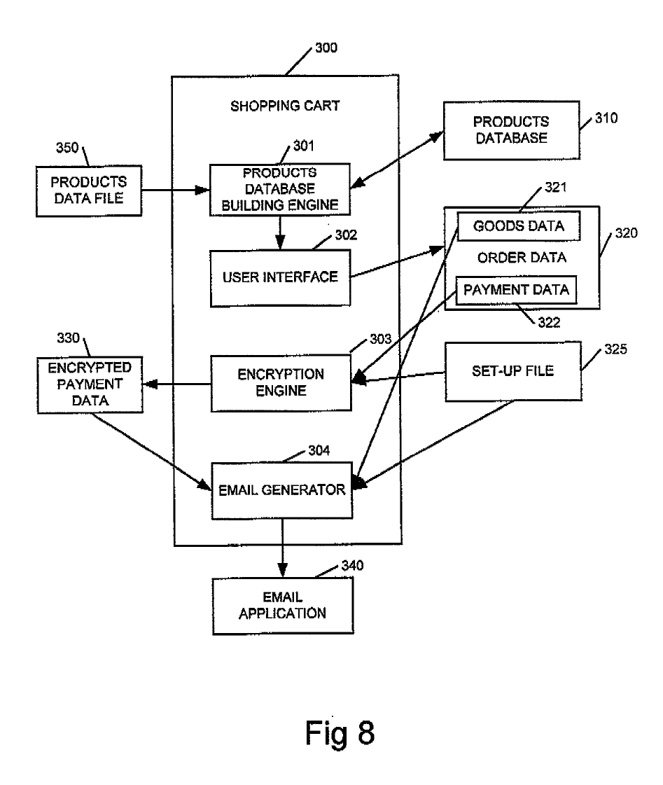

FIG. 8 is a schematic diagram of the logical units in the shopping client system in the embodiment, and

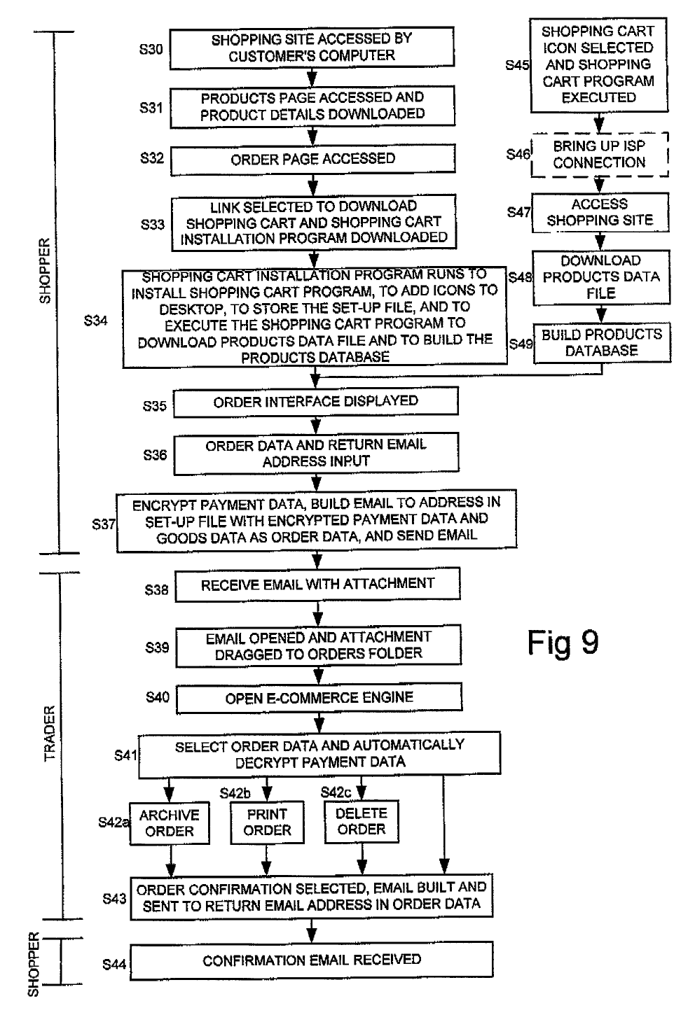

FIG. 9 is a flow diagram illustrating the method of placing a purchase order for a product with the product trader in accordance with the embodiment.

FIG. 1 is a schematic diagram of the e-commerce system in accordance with an embodiment of the present invention.

A shopper is provided with a shopping client computer 1 which can access the Internet 3 to enable them to browse the Internet. A trader's computer 2 is also connected to the Internet 3 by virtue of an arrangement with an Internet Service Provider (ISP) which provides a server 4 to host the trader's website. The trader will thus typically set up an e-commerce website on the server 4, but since this is hosted by an Internet Service Provider they have no control over the capability provided by the Internet Service Provider. In this embodiment of the present invention there is no requirement of the server over and above the minimal functionality required to be provided by a web server. The web server 4 does not provide the capability to execute any form of scripts such as active server pages, CGI scripts, Java scripts of Perl scripts.

Also provided in FIG. 3 is an e-commerce manager 5 to provide a central database of programme code which can be accessed by the shopper 1 when necessary in order to place a purchase order as will be described in more detail hereinafter.

In this embodiment the trader system 2 acts as a trader client system and can be implemented on a general purpose computer which is suitably programmed. This is schematically illustrated in FIG. 2.

In FIG. 2 the trader client system includes a conventional keyboard 10, display 20 and pointer device such as a mouse 50. A network interface 80 such as a modem or router provides a connection to the Internet 3. A data storage device 60 is provided such as a hard disk drive, floppy disk drive, or CD ROM in which is stored various data required during operation of the trader system. Within the data storage device 60 web templates, a products database, a products data file, a set-up file, HTML (Hypertext Markup Language) files, (web pages), shopping cart installation code, shopping cart programme code, company details, configuration parameters and product image files are stored.

The programme storage device 70 is provided which can comprise any conventional storage device which can be shared with the data storage device 60 or can be separate. The programme storage device 70 can be provided by any conventional storage device such as a floppy disk drive, hard disk drive, or CD ROM. The programme storage device 70 stores programme code which is readable and implementable by a processor 30. All of the components in the system are linked by a data and control bus 40.

In operation, as will be described in more detail hereinafter, the processor 30 loads and executes programme code from the probe storage device 70 to implement an e-commerce engine installation application 30a, an e-commerce engine 30b, and e-mail application 30c, a web editor 30d, and a database application 30e.

FIG. 3 schematically illustrates the functional units in the trader system. The e-commerce engine, once installed on the computer, implements several functions. It includes a product editor 101 for reading the products database 110 to enable the product data, such as information on the products and product price, to be edited. The product editor 101 can also access the products image file 109 which includes a set of images to be made available on the website to give the customer a view of the products which they can order. Also within the e-commerce engine there is a website design engine 102. The website design engine uses products data from the products database 110, web templates 111, company details 112 and the configuration parameters 115, in order to generate HTML 116. The engine 102 also uses the shopping cart program code 114 and the set-up file 113 to generate a shopping cart installation programme 117. Further, the engine 102 uses the products database 110 to generate a product data file 118. The products image files 109, the HTML files 116, the shopping cart installation programme 117 and the product data file 118 are the files which are uploaded to the server to provide the e-commerce capability.

Also within the e-commerce engine them is provided an FTP engine 103 which uses information available in the configuration parameters 115 (e.g., the FTP URL) to upload the files to the server.

A decryption engine 104 is provided within the e-commerce engine 100 to read orders which are placed in an orders folder 119 so as to be able to decrypt the orders. An e-mail generator 105 is also provided within the e-commerce engine 100 to cooperate with an e-mail application 108 in order to automatically generate an e-mail acknowledgement of the order.

The operation of the trader system will now be described in more details with reference to flow diagrams of FIGS. 4 and 5.

FIG. 4 is a flow diagram illustrating the steps of a process in order to install the e-commerce engine on the trader system in order to provide the capability to configure the shopping server.

The e-commerce installation application is provided on a suitable carrier medium such as a floppy disk drive, CD ROM, magnetic tape, programmable memory device or as a download over the Internet and in step S1 the installation application is executed to generate a user interface. The installation application installs certain files in the system and sets up the e-commerce engine 100 and the fictional units to the left of the e-commerce engine 100 in FIG. 3, i.e., the products database 110, the web templates 111, the company details 112, the set-up file 113, the shopping cart programme 124, the configuration parameters 115, and the orders folder 119.

In step S2 the user inputs the product identification code in order to authenticate the copy. In step S3 the user will then input the Internet Service Provider (ISP) name and this will be used to identify parameters to be used for connecting to the ISP. In step S4 the URL of the website on which the e-commerce site is to be placed is input by the user and in step S5 the FTP address used for the uploading of the files to the server is input. In step S6 company information is input to form the company details 112. The company details include the company name, description, keywords and e-mail address. The e-mail address is stored not with the company details 112, but in the set-up file 113 to be used as the address to which all purchase orders are sent.

Having input all the necessary parameters from the user in step S7 the application makes a connection to the Internet Service Provider by dialling-up the remote access server of the Internet Service Provider if this is necessary. If the connection is already made to the Internet Service Provider e.g., over a local area network, the step can be omitted.

The application then connects to the e-commerce manager 5 and downloads update files, the shopping cart programme code, and the e-commerce engine programme code (step S8). Thus the application as provided to the general purpose computer is incomplete. Further code must be obtained from the e-commerce manager 5. This facility enables more up-to-date code to be maintained at the e-commerce manager 5.

In step S9 the computer is scanned to identify the hardware and software configuration and these configurations are stored.

In step S10 a random number is generated for the encryption process and this is stored in the set-up file as part of the encryption key. Thus the set-up file includes the random number comprising part of the key for encryption as well as the e-mail address for the company to which the orders are to be sent

The final step in the configuration is the execution of the commerce engine in step S11 using the configuration parameters and set-up file.

Thus the result of the installation process is a fully configured e-commerce engine 100 with the necessary files to provide for the operation of the e-commerce engine to enable the generation of configuration data for the server.

The process of generating the configuration data will now be described in detail with reference to the flow diagram of FIG. 5.

Using the e-commerce engine, web templates can be accessed and chosen by a user (step S20). Also products in the products database 110 can be edited using the product editor 101 (step S21). The web design engine 102 at the heart of the e-commerce 100 then uses the products database 110, the web templates 111, the company details 112, the set-up file 113, and configuration parameters 115 in order to build the HTML for the web pages (step S22). Thus the web pages are built automatically. A user can however, use a web editor 30d of their own choice to manually edit the HTML. Also, the products database 110 can be edited not just using the product editor 101 but also using a standard database application 30e since the products database is set up as a conventional database file.

In step S23 the website design engine 102 builds the shopping cart installation programme 117 using the shopping cart programme 114 and the set-up file 113. Also the website design engine 102 builds a product data file 118 using the products database 110. The products data file 118 simply comprises text such as a comma separated variable file. The products database 110 is converted to a product data file 118 in order to reduce the file size and to thereby decrease the download speed when a shopper accesses a website.

In step S25 a user selects to upload the web pages to the e-commerce site by FTP and a password is input. In step S26 the FTP engine 103 uploads the product image files 109, the HTML files 116, the shopping cart installation programme 117 and the product data file 118 to the web space allocated at the server by the ISP for the trader.

Thus the trader has created an e-commerce site which comprises web pages giving information on the products including the price of the products and where appropriate images of the products.

FIG. 6 is a schematic diagram of the server system in accordance with the embodiment of the present invention.

The server comprises any conventional server generally provided by a ISP. The server comprises a conventional keyboard 120, display 130 and pointer device 160 such as a mouse. A network interface 190 is provided to provide the connection to the Internet 3. A programme storage device 180 is provided to store web server programme code implementable by a processor to implement a web server application 140a. Each of the components are interconnected by a conventional data and control bus 150.

A data storage device 170 is provided in which is stored HTML files (web pages), the shopping installation programme code, the products data file, and the products image files. Thus the server system provides a conventional web server for hosting the web site wherein the HTML files are sent to the client in response to HTML GET requests. Also the image files are sent in response to further requests in order to display the web pages at the browser. Over and above a conventional web site the shopping installation programme code and the products data file are provided.

The customer system will now be described in more detail with reference to FIGS. 7 to 9.

FIG. 7 is a schematic diagram of the customer system which can be implemented by the supply of programme code to a general purpose computer.

The system is provided with a conventional keyboard 200, display 201 and pointer device 204 such as a mouse. A network interface 207 is provided is to enable the system to connect to the Internet 3. The network device 207 can comprise a dial-up device such as a modem, or a network device such as a network card or router. A data storage device 205 is provided which can comprise any conventional data storage device such as a floppy disk, hard disk drive, CD ROM, magnetic tape device, or programmable memory device. The data storage device 205 is provided to store data used during the operation of the system. The data stored comprises the products database, the products data file and the set-up file,

A programme storage device 206 is provided for storing programmes which are readable and executable by a processor 202. The programme storage device 206 can comprise any conventional storage device shared with the data storage device 205 or independent thereof such as a CD ROM, floppy disk drive, hard disk drive, magnetic tape device, or programmable memory device. Programme code stored in the programme storage device 206 is readable by the processor 202 to implement a web browser application 202a, a shopping cart installation programme 202b, a shopping cart programme 202c, a connection application 202d, and an e-mail application 202e.

All the components of the customer system are interconnected by a standard data and control bus 203.

In this embodiment although a separate connection application 202d is described, the connection application can be implemented by the computer operating system such as Microsoft Windows 98 (Trade Mark).

FIG. 8 is a diagram of the functional units of the computer system.

A shopping cart application 300 includes a product database building engine 301 for reading the products data file 350 and generating a products database 310. A user interface 302 generates a graphical user interface (GUT) using the product data read from the products database 310. As a result of user input using the user interface 302 in the shopping cart application 300, order data 320 is generated which comprises goods data 321 e.g., a description of the goods, quantity required, and cost, and payment data 322 which includes sensitive information on how the goods are to be paid for e.g. credit card information. An encryption engine 303 is also provided in the shopping cart application 300. The encryption is performed using the random number included in the set-up file 325. The result is thus encrypted payment data 330 and this is taken together with the goods data 321 by an e-mail generator 304 within the shopping cart application 300 which interacts with an e-mail application such as Microsoft Outlook (Trade Mark) in order to generate an order as an e-mail. The e-mail generator will use the address given in the set-up file 325 as the destination address for the e-mail.

The method of placing a purchase order using the customer system will now be described in more detail with reference to flow diagram of FIG. 9.

In step S30 a customer accesses the shopping site on the server and in step S31 and products web pages are accessed and product details downloaded as web pages to enable a customer to choose to place an order, When a customer chooses to place an order, in step S32 the order web page is accessed. On the order page a link is then selected to download the shopping cart (step S33) and the shopping cart installation programme is then downloaded from the server to the shopping client (the customer's computer).

In step S34 the shopping cart installation programme is selected to be run by the customer. The shopping cart installation programme installs the shopping cart programme onto the customer system and adds icons to the Windows operating system (trade mark) desktop. The shopping cart programme is then run to connect to the server to download the products data file. Once the products data files has been retrieved from the server, it is used to build the products database. Thus when the shopping cart installation programme is run it installs the shopping cart programme and stores the set-up file which is used by the shopping cart programme. It is only when the shopping cart programme is executed that the products data file is downloaded in his embodiment.

Steps S30 to S34 described hereinabove are cared out when a customer accesses the shopping site for the first time. When a customer wishes to place a purchase order next time, they need not access the shopping site and download the shopping cart programme since this is already on the machine. Instead in step S45 the shopping cart icon can be selected and the shopping cart programme will execute. In step S46 if a connection to the Internet Service Provider is not already up, such a connection is made by the shopping car program and in Step S47 the shopping site is accessed. In step S48 the products data file is then downloaded and in step S49 the products database is built. Thus for each subsequent order, as soon as the shopping cart is executed, it accesses the shopping site to download the latest version of the products data file. This enables a trader to keep the products data file up to date and ensures that a customer will always access the, latest products data The products data file comprises text to reduce download time and thus it is converted to a database for use by the shopping cart program.

When the shopping cart is executed and the products database has been built, in step S35 an order interface is displayed. The order interface displays information about the products i.e., a brief description of the products and their price. In step S36 the user is able to select products to be ordered including a number of products to be ordered and can input a return e-mail address for acknowledgement of the order.

In step S37 the encryption engine 303 encrypts the payment data 322 and the e-mail generator 304 builds an e-mail to the address in the set-up file. The e-mail comprises the encrypted payment data 322 and the goods data 321 as an attachment. The goods data 321 is not encrypted since this comprises public information available on the website. The payment data 322 is encrypted however for security reasons since this will typically comprise credit card information which should not fall into the hands of unauthorised persons. The e-mail generator 304 then passes information to an e-mail application 340 for the sending of the e-mail to the address given in the set-up file 325.

Thus steps S30 to S37 describe hereinabove describe the process implemented on the customer system for the generation of a purchase order for reception by a product trader.

In step S38 the e-mail is received by the trader system with the attachment generated by the e-mail generator. The trader will then open the e-mail and drag the attachment into the orders folder 119 (step S39). In step S40 the trader can then open the commerce engine application if this is not already open and in step S41 the user can select order data from the orders folder 119 for automatic decryption of the payment data. In this way the order data can be read and understood by the trader. The order data can then be stored in an order archive (step S42a) printed (step S42b) or deleted (step S42c). In step S43 the trader can select to send an automatic confirmation e-mail and this is built and sent to the return address given in the order data. In step S44 the confirmation e-mail is then received by the shopper.

Steps S38 to S43 described hereinabove are implemented by the trader system and comprise the steps for receiving and processing the purchase order,

Although the present invention has been described hereinabove with reference to a specific embodiment, it will be apparent to a skilled person in the art that modifications lie within the spirit and scope of the present invention. The present invention provides an e-commerce system in which an executable shopping cart is downloaded to the shoppers computer so that an order is generated on the shoppers computer and sent to the trader. This removal of the burden for generating orders from the server to the clients greatly reduces the cost and complexity to small businesses of setting up a website which enables orders for products to be securely made to the small business. In order to set up the system no knowledge or understanding is needed of the server provided as part of the ISP service. In the specific embodiment the system enables the simple transfer of orders securely by encrypted e-mails.

1. A method of placing a purchase order for a product over a communication network the method comprising:
accessing an information site on a shopping server using a shopping client;
downloading programme code for executing a shopping cart to the shopping client from the shopping server;
executing the programme code at the shopping client to generate a purchase order interface for a user;
receiving product selection data and payment data at the shopping client;
generating order data at the shopping client using the received selection data and payment data;
encrypting at least the payment data of the order and at the shopping client; and
transmitting the order data from the shopping client over the communications network to a location for reception by the product trader.

2. A method according to claim 1 wherein the information site comprises a web page for the product trader providing information on products which can be purchased from the product trader and the programme code and product data are downloaded in response to a selection by the user of the shopping client.

3. A method according to claim 1 or claim 2 wherein the execution of the program code causes product data to be downloaded from the shopping server, to the shopping client, the product data being used to generate the purchase order interface.

4. A method according to claim 1 or claim 2 wherein the execution of the program code causes a determination to be made as to whether product data needs to be downloaded, and downloading the product data from the shopping server to the shopping client if the product data is determined to need to be downloaded.

5. A method according to claim 1, 2, or 4 wherein the downloading of the program code includes the downloading of product data for use during the execution of the program code to generate the purchase order interface.

6. A method according to claim 1 wherein when the program code is executed a connection is made to the shopping server.

7. A method according to claim 6 wherein the connection comprises a TCP/IP session.

8. A method according to claim 6 or claim 7 wherein the connection process includes making a dial-up connection if no physical connection exists to the network when the programme code is executed.

9. A method according to claim 1 wherein the transmitting process comprises transmitting the order data for storage at a storage location at the shopping server for reception by the product trader by retrieval of the order data to a trader client.

10. A method according to claim 1 wherein the transmitting process comprises transmitting the order data in an e-mail to an e-mail address for the product trader.

11. A method according to claim 1 wherein the order data is transmitted to a location identified in data downloaded with the program code from the shopping server.

12. A method according to claim 1 wherein the encryption is carried out based on key information downloaded with the program code from the shopping server.

13. A method according to claim 1 including sending an acceptance of the order from the product trader to the shopping client.

14. A method according to claim 1 wherein the program code comprises first program code for execution to provide the shopping cart and second program code for installing the first program code on the shopping client, and the execution process includes an initial execution of the second program code to install the first program code on the shopping client.

15. A method according to claim 1 including, at a trader client:
generating product data to be downloaded with the program code to generate the purchase order interface;
generating information to be used to form the information site; and
uploading the product data, the generated information and the program code to the shopping server.

16. A method according to claim 15 wherein the generated information comprises Hypertext Markup Language generated using the product data.

17. A method according to claim 15 wherein the Hypertext Markup Language is generated using templates.

18. A method according to claims 15 or 16 including, at the trader client, generating key information for use by the shopping client for the encryption of at least the payment data, and uploading the key information to the shopping server.

19. A method according to claim 15 including, at the trader client, designating the location for reception of the order data by the product traders and uploading the designated location to the shopping server.

20. A method according to claim 15 including generating installation program code for installing the program code on the shopping client, and uploading the installation program code in combination with the program code for executing the shopping cart to the shopping server.

21. A client apparatus for the placement of a purchase order with a product trader for a product over a communication network, the apparatus comprising:
a program store storing program code executable by a processor, and
a processor for executing the program code stored in the program store;
wherein the program code comprises
code for executing a shopping cart including code for generating a purchase order interface and receiving product selection data and payment data from a user, code for generating order data using the received selection data and payment data, code for encrypting at least the payment data, and code for transmitting the order data over the communications network to a location for reception by the product trader.

22. A client apparatus according to claim 20 including a product data store, wherein the code for executing the shopping card includes code for retrieving product data from a shopping server and storing the product data in the product data storage, and the code for generating the purchase order interface is arranged to use the product data to generate the purchase order interface.

23. A client apparatus according to claim 21 including a product data store, wherein the code for executing the shopping cart includes code for determining whether product data needs to be downloaded and if so downloading product data from a shopping server and storing the product data in the product data store, and the code for generating the purchase order interface is arranged to use the product data to generate the purchase order interface.

24. A client apparatus according to clam 21 including a product data store for storing product data, wherein the code for generating the purchase order interface is arranged to use the stored product data to generate the purchase order interface.

25. A client apparatus according to claim 22 or claim 23 wherein the program code includes code for making a connection to the shopping server.

26. A client apparatus according to claim 25 wherein the code for making the connection is arranged to set up a TCP/IP session.

27. A client apparatus according to claim 25 or claim 26 including a mode, wherein the code for making the connection is arranged to control the modem to make a dial-up connection if no physical connection exists to the network.

28. A client apparatus according to claim 21 wherein the code for transmitting the order data is arranged to transmit the order data for storage at a storage location at a shopping server for reception by the product trader by retrieval of the order data to a trader client.

29. A client apparatus according to claim 21 wherein the code for transmitting the order data is arranged to cooperate with an e-mail application to send an e-mail to an email address for the product trader.

30. A client apparatus according to claim 21 including a location store for storing information on the location to which the order data is to be sent, wherein the code for transmitting the order data is arranged to transmit the order data to the location in the location store.

31. A client apparatus according to claim 21 including a key store for storing encryption key information, wherein the code for encrypting is arranged to use the key information for the encryption of at least the payment data.

32. A client apparatus for the placement of a purchase order with a product trader for a product over a communications network, the apparatus comprising:
downloading means for downloading program code for executing a shopping cart from a shopping server; and
means for executing the program code to generate a purchase order interface for a user, to receive product selection data and payment data from the user, to generate order data using the received selection data and payment data, to encrypt at least the payment data, and to transmit the order data over the communications network to a location for reception by the product trader.

33. A client apparatus according to claim 32 wherein the information site comprises a web site for the product trader providing information on products which can be purchased from the product trader, and the downloading means is arranged to download the program code in response to a selection by the user.

34. A client apparatus according to claim 32 wherein the executing means is arranged to cause product data to be downloaded from the shopping server, and to use the product data to generate the purchase order interface.

35. A client apparatus according to claim 32 wherein the executing means is arranged to determine whether product data needs to be downloaded, and to download the product data from the shopping server of the product data is determined to need to be downloaded.

36. A client apparatus according to claim 32 wherein the downloading means is arranged to download product data, and the executing means is arranged to use the downloaded product data for the generation of the purchase order interface.

37. A client apparatus according to claim 32 wherein the executing means is arranged to make a connection to the shopping server.

38. A client apparatus according to claim 37 wherein the executing means is arranged to form a TCP/IP session.

39. A client apparatus according to claim 37 or claim 38 including a modem,
wherein the executing means is arranged to control the modem to make a dial-up connection if no physical connection exists to the network.

40. A client apparatus according to claim 32 wherein the executing means is arranged to transmit the order data for storage at a storage location at the shopping server for reception by the product trader by retrieval of the order data to a trader client.

41. A client apparatus according to claim 32 wherein the executing means is ranged to transmit the order data in an e-mail to an e-mail address for the product trader.

42. A client apparatus according to claim 32 wherein the executing means is arranged to transmit the order data to a location identified in data downloaded with the program code from the shopping server.

43. A client apparatus according to claim 32 wherein the executing means is arranged to carry out the encryption based on key information downloaded with the program code from the shopping server.

44. A client apparatus according to claim 32 including means for receiving an acceptance of the order from the shopping trader.

45. A method of configuring a shopping server accessible by a shopping client over a communications network for the download of programme code for executing a shopping cart and product data to allow a user to enter product selections and payment data to enable the encryption of at least the payment data and to enable the transmission over the network of order data formed using the encrypted data, the method composing:
generating product data including product information and cost information;
generating information to be accessed by the shopping client; and
storing the product data the generated information, and programme code for executing the shopping cart at the shopping server.

46. A method according to claim 45 where the shopping server is configured remotely by the implementation of the generating processes at a trader client and the storing is performed by sending the product data, the generated information and the program code from the trader client to the shopper server.

47. A method according to claim 45 wherein the generated information comprises Hypertext Markup Language generated using the product data.

48. A method according to claim 47 wherein the Hypertext Markup Language is generated using templates.

49. A method according to claim 45 including generating key information for use by the shopping client for the encryption of at least the payment data, storing the key information at the shopping server and decrypting received order data from shopping clients.

50. A method according to claim 45 including generating installation program code for installing the programme code on the shopping client, and storing the installation programme code in combination with the program code for executing the shopping cart at the shopping sever.

51. A trader client for configuring a shopping server accessible by a shopping client over a communications network for the download of program code for executing a shopping cart and product data, to allow a user to enter product selections and payment data, to enable the encryption of at least the payment data, and to enable the transmission over the network of order data formed using the encrypted data, the trader client comprising:
product data generating means for generating product data including product information and cost information;
information generating means for generating information to be accessed by the shopping client; and
uploading means for uploading the product data, the generated information, and program code for executing the shopping cart at the shopping client to the shopping server.

52. A trader client according to claim 51 wherein the generated information comprises Hypertext Markup Language generated using the product data.

53. A trader client according to claim 52 wherein the Hypertext Markup Language is generated using templates.

54. A trader client according to claim 51 including means for generating key information for use by the shopping client for the encryption of at least the payment data, wherein the uploading means is adapted to upload the key information to the shopping server, and the trader client includes decryption means for using the key information to decrypt received order data from shopping client.

55. A trader client according to claim 51 including means for generating installation programme code for installing the programme code on the shopping client wherein the uploading means is adapted to upload the installation program code in combination with the program code for executing the shopping cart at the shopping client.

56. A trader client for configuring a shopping server accessible by a shopping client over a communications network for the download of program code for executing a shopping cart and product data, to allow a user to enter product selections and payment data, to enable the encryption of at least the payment data, and to enable the transmission over the network of order data formed using the encrypted data, the trader client comprising:
a program store storing program code executable by the processor; and
a processor for reading and executing the program code in the program store;
wherein the program code comprises code to generate product data including product information and cost information, code for generating information to be accessed by the shopping client, and code for uploading the product data, the generated information and program code for executing the shopping cart at the shopping client to tile shopping server.

57. A trader client according to claim 56 wherein the generated information comprises Hypertext Markup Language generated using the product data.

58. A trader client according to client 57 wherein the Hypertext Markup Language is generated using templates.

59. A trader client according to claim 56 wherein the stored program code includes code for generating key information for use by the shopping client for the encryption of at least the payment data, wherein the code for uploading is arranged to upload the key information to the shopping server, the stored program code including code for using the key information to decrypt received order data from shopping clients.

60. A carrier medium carrying a computer readable code for controlling a computer to carry out the method of any one of claims 1 to 20 or 45 to 50.
